(19) United States
(12) Patent Application Publication
(10) Pub. No.: US 2026/0002007 A1
(43) Pub. Date: Jan. 1, 2026

(54) LIGHT-WEIGHTING BIORESIN WITH GAS ASSIST

(71) Applicant: L'Oreal, Paris (FR)

(72) Inventors: Krishna BHUTADA, Morganville, NJ (US); Matthew FORRESTER, Bessancourt (FR); Stéphane LESPRIT, Mâcon (FR); Antoine SABATTINI, Houilles (FR); Jason FYFE, Holmdel, NJ (US); Michael TOGNETTI, Cranford, NJ (US)

(73) Assignee: L'Oreal, Paris (FR)

(21) Appl. No.: 19/248,668

(22) Filed: Jun. 25, 2025

Related U.S. Application Data
(60) Provisional application No. 63/664,982, filed on Jun. 27, 2024.

(30) Foreign Application Priority Data
Aug. 27, 2024 (FR) 2409130

(51) Int. Cl. C08J 9/12; C08J 9/00; C08L 99/00

(52) U.S. Cl. CPC C08J 9/122; C08J 9/0061; C08L 99/00; C08J 2201/03; C08J 2203/06; C08J 2399/00; C08J 2423/06; C08J 2423/12; C08L 2203/14

(57) ABSTRACT

A method of making a bio-based cellular plastic comprises obtaining pellets of a non-cellular plastic having a density less than 1 g/cm³; obtaining an algae product having a density greater than 1 g/cm³; injection molding the plastic pellets and the algae product including introducing a chemical blowing agent, a physical blowing agent, or both; and producing a bio-based cellular plastic having a density equal to or less than 0.98 g/cm³.

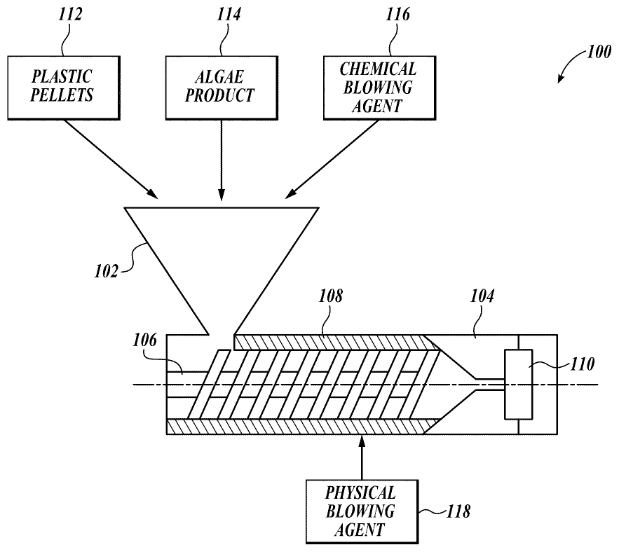

### CROSS-REFERENCE(S) TO RELATED APPLICATION(S)

This application claims the benefit of U.S. Provisional Application No. 63/664,982, filed on Jun. 27, 2024. This application claims priority of French Application No. FR 2409130, filed on Aug. 27, 2024. Both applications are expressly incorporated by reference for all purposes.

### SUMMARY

This disclosure is directed to methods to introduce gas assist (or injection) into a bio-based plastic resin mixture to produce plastic components that are made less dense and can be recycled and to the packages made using the lighter bio-based plastic resin mixture. This can potentially be achieved by physical foaming (for example using nitrogen or carbon dioxide), chemical foaming, or additives such as micro-spheres.

As bio-based sources are rather heavy (in density), this poses an issue with recyclability. Certain bio-based composite plastics (e.g., those including polypropylene or polyethylene) can become disruptors for other plastics (e.g., polyethylene terephthalate) when the density of the former is equal to or greater than 1 g/cm³, as a waterbath is used to separate the materials by flotation. The goal would be to lower the bio-based composite plastic density to be less than 1 g/cm³ so the bio-based composite plastic resin will float, and be properly recycled into the right stream. Targeting plastic resins like PP and PE and modifying their density via physical or chemical foaming or through additives to ensure the density remains less than 1 g/cm³ will ensure the plastic enters the correct recycling stream and steer clear from other streams.

The disclosure related to introducing a foaming agent, or combination of foaming agent and/or a gas assist into a bio-based plastic resin.

The disclosure relates to an applicator or packaging structures including structures made from aerated bio-based resin mixtures wherein the total material compound density is equal to or less than 0.98 g/cm³, for example, a mix of virgin, recycled and/or aerated bio-resins.

Using an algae-containing bio-based resin as an example, the non-cellular density of the bio-based resin is greater than 1 g/cm³, for example from about 1.1 to about 1.7 g/cm³, and in one embodiment about 1.4 g/cm³. However, when a physical or chemical foaming agent or gas assist is introduced into the bio-based resin, the total plastic compound density can be equal to or less than 0.98 g/cm³. This reduction in density is a combination of the bio-based resin, any virgin plastic resin, and the physical foaming agent. For example, it is possible with physical foaming to reduce the density of a composition, including, for example, 20% bio-based resin and 80% plastic to a density of 0.98 g/cm³ or less.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

The FIGURE is a schematic illustration showing an injection molding system with physical or chemical blowing agent introduction.

### DETAILED DESCRIPTION

Industry has sought ways of reducing the use of plastics made from fossil fuels, such as petroleum and coal, in order to reduce pollution. Bio-based plastics are made from natural polymers, such as carbohydrates and proteins. However, the use of algae as a source of bio-based plastic has advantages over sourcing carbohydrates and proteins from terrestrial crops.

There are a plurality of processes for incorporating algae or an algae product into plastics. An example of a method of making an algae powder is described in US Patent Application Publication 2018/0258231, incorporated herein expressly be reference for all purposes. In general terms, the process of this publication includes culturing and/or harvesting an algal biomass, reducing by at least 10% the intrinsic amount of proteins of the algae, by weight relative to the weight of proteins of the harvested biomass, drying, and reducing to give powder or granules.

Specifically, the process according to Publication 2018/0258231 includes carrying out an enzymatic hydrolysis of the proteins of the algae and the separation of the protein matter obtained, which is rich in peptides and amino acids, from an algal residue in which the content of proteins is significantly reduced.

The present disclosure relates to the use of algae products, such as the algae powder described in US Publication 2018/0258231 with resins in an injection molding process to produce cellular bio-based plastics having a density equal to or less than 0.98 g/cm³. Generally, a reduction in fossil-based polymers in a compound is better for the environmental impact. However, a problem when incorporating an algae product with a plastic resin, such as propylene, is the increase in density of the resulting plastic. The disclosure aims to reduce the density of the bio-based plastic by introducing a chemical or a physical or both chemical and a physical blowing agent in the molding process.

Non-cellular is used herein to mean without bubbles or voids. Cellular refers to a plastic that has cells, gas bubbles, or voids introduced by a physical or chemical blowing agent. Non-cellular polypropylene (pp) has a density generally from 0.895 to 0.97 g/cm³, depending on whether it is amorphous or crystalline. Non-cellular polyethylene (pe) has a density general from 0.88 to 0.96 g/cm³. The density of polyethylene increases with crystallinity. Non-cellular ethylene vinyl acetate (eva) has a density of 0.92 to 0.97 g/cm³. A density less than 1 g/cm³ allows polypropylene or polyethylene or ethylene vinyl acetate to be separated by floatation separation in fresh water, which generally has a density of 1 g/cm³. Floatation separation has become a commonly used method to segregate a stream of mixed plastic types for recycling. However, when the density of a bio-based plastic composite, including polypropylene, is greater than about 0.98 g/cm³, floatation separation in water ceases to be viable way of segregating polypropylene, thereby, becoming disruptive to recycling facilities which may refuse to accept the bio-based plastic.

The FIGURE is an illustration of a representative injection molding system 100. A representative injection molding system 100 includes a transfer screw 106 within a casing, a heater 108 surrounding the transfer screw to melt the plastic pellets. The screw 106 pushes the plastic melt into a mold 110, which can then be separated to recover the product.

In an embodiment, the non-cellular plastic pellets 112, the algae product 114 and a chemical blowing agent 116 are added into a hopper 102 which leads into the transfer screw 106.

In an embodiment, the non-cellular plastic pellets 112, the algae product 114 are introduced into the hopper and a physical blowing agent 118 is introduced directly into the transfer screw 106. Pellets 112 of non-cellular plastic can include, but are not limited to, nonfossil-based plastic, virgin plastic, post-consumer recycled plastic, post-industrial recycled plastic, or a chemically recycled plastic

A suitable chemical blowing agent 116 can decompose when heated producing a gas or gases which will appear as voids or cells in the molded plastic part. Commonly used blowing agents include azo compounds, hydrazides, nitroso compounds, carbamates, carbazides, bicarbonates, polycarboxylic acids, and salts of polycarboxylic acids. See US Publication 2022/0372238.

A suitable physical blowing agent 118 is a gas, such a nitrogen gas or carbon dioxide gas. Physical blowing agent 118 can be introduced directly in the transfer screw section to mix directly with the melt mixture. The physical blowing agent will appears as voids or cell in the molded plastic part.

Suitable algae products 114 are derived from microalgae or macroalgae, such as green algae (Chlorophyceae), brown algae (Phaeophyceae) or red algae (Rhodophyceae), or algae of the genus Ulva or of the family Sargassaceae. Examples of green algae are from the genus Ulva, such as Ulva armoricana or Ulva lactuca. Examples of microalgae are from the genus Chlorophyceae or diatoms.

A non-cellular plastic can include a plastic having a density less than 1 g/cm³. When the non-cellular plastic has a density less than 1 g/cm³, floatation separation in fresh water can be performed. A non-cellular polypropylene (pp) has a density generally from 0.895 to 0.92 g/cm³. Low and high density non-cellular polyethylene (pe) has a density from 0.88 to 0.97 g/cm³. Non-cellular ethylene vinyl acetate (eva) has a density of 0.92 to 0.97 g/cm³. The non-cellular polypropylene, ethylene, and ethylene vinyl acetate can include additives, such as fibers, minerals, talc, in percentages such that the density is below 1.00 g/cm³. The non-cellular polypropylene, ethylene, and ethylene vinyl acetate can be up to 100% by weight of the respective polymer.

Flotation separation intends to separate PP and PE from PET. Therefore, plastics with a density greater than 1 (i.e., PET) are appropriately segregated via sink float. The intent is for PP and PE to not become disruptors of the PET stream.

An algae product includes starch, proteins, and other compounds naturally found in algae. The algae is processed to provide a form suitable to be mixed with plastics in injection molding, extrusion, and the like plastic forming processes. Generally, the algae product has been processed and has a density greater than 1 g/cm³.

In an embodiment, the weight ratio range of algae product to the non-cellular plastic is 0.25 or less, but greater than 0.01. The amount of chemical or physical blowing agent is determined to give a density of 0.98 g/cm³ or less of the molded bio-based cellular plastic.

A method of making a bio-based cellular plastic comprises obtaining pellets of a non-cellular plastic having a density less than 1 g/cm³; obtaining an algae product having a density greater than 1 g/cm³; injection molding the plastic pellets and the algae product including introducing a chemical blowing agent, a physical blowing agent, or both; and producing a bio-based cellular plastic having a density equal to or less than 0.98 g/cm³. The method may include a step of adding additives into the mix, for example, colorants, plasticizers, UV stabilizers, and the like.

The non-cellular plastic is a nonfossil-based plastic. The plastics used can be virgin, post-consumer recycled, post-industrial recycled, and/or chemically recycled plastics.

The non-cellular plastic is a polyolefin.

The non-cellular plastic has a density from 0.88 to 0.97 g/cm³.

The non-cellular plastic comprises polypropylene or a polyethylene or ethylene vinyl acetate, or any composite including one or more of these polymers.

The algae product is a powder that has at least 10% by weight of the proteins removed.

The weight ratio range of the algae product to the non-cellular plastic is 0.25 to 0.01. The weight ratio range of the algae product to the non-cellular plastic is 0.20 to 0.01. The weight ratio range of the algae product to the non-cellular plastic is 0.15 to 0.01. The weight ratio range of the algae product to the non-cellular plastic is 0.10 to 0.01.

The physical blowing agent is nitrogen or carbon dioxide.

The non-cellular plastic is polypropylene. The polypropylene may include additives, for example, colorants, plasticizers, UV stabilizers, and the like.

The non-cellular plastic is polyethylene. The polyethylene may include additives, for example, colorants, plasticizers, UV stabilizers, and the like.

A bio-based cellular plastic made by the method above, comprises a mixture of polypropylene or polyethylene or both with the algae product; and the bio-based plastic has a density equal to or less than 0.98 g/cm³; and cells within the plastic.

The weight ratio range of the algae product to the polypropylene or polyethylene is 0.25 to 0.01. The weight ratio range of the algae product to the polypropylene or polyethylene is 0.20 to 0.01. The weight ratio range of the algae product to the polypropylene or polyethylene is 0.15 to 0.01. The weight ratio range of the algae product to the polypropylene or polyethylene is 0.10 to 0.01.

The bio-based cellular plastic is configured to be separated in floatation separation in fresh water.

While illustrative embodiments have been illustrated and described, it will be appreciated that various changes can be made therein without departing from the spirit and scope of the invention.

1. A method of making a bio-based cellular plastic, comprising:
obtaining pellets of a non-cellular plastic having a density less than 1 g/cm³;
obtaining an algae product having a density greater than 1 g/cm³;
injection molding the plastic pellets and the algae product including introducing a chemical blowing agent, a physical blowing agent, or both; and
producing a bio-based cellular plastic having a density equal to or less than 0.98 g/cm³.

2. The method of claim 1, wherein the non-cellular plastic is a nonfossil-based plastic, virgin plastic, post-consumer recycled plastic, post-industrial recycled plastic, or a chemically recycled plastic.

3. The method of claim 1, wherein the non-cellular plastic is a polyolefin.

4. The method of claim 1, wherein the non-cellular plastic has a density from 0.88 to 0.97 g/cm³.

5. The method of claim 1 wherein the non-cellular plastic comprises polypropylene or a polyethylene or ethylene vinyl acetate.

6. The method of claim 1, wherein the algae product is a powder that has at least 10% by weight of the proteins removed.

7. The method of claim 1, wherein the weight ratio range of the algae product to the non-cellular plastic is 0.25 to 0.01.

8. The method of claim 1, wherein the weight ratio range of the algae product to the non-cellular plastic is 0.20 to 0.01.

9. The method of claim 1, wherein the weight ratio range of the algae product to the non-cellular plastic is 0.15 to 0.01.

10. The method of claim 1, wherein the weight ratio range of the algae product to the non-cellular plastic is 0.10 to 0.01.

11. The method of claim 1, wherein the physical blowing agent is nitrogen or carbon dioxide.

12. The method of claim 1, wherein the non-cellular plastic includes polypropylene.

13. The method of claim 1, wherein the non-cellular plastic includes polyethylene.

14. A bio-based cellular plastic made by the method of claim 1, comprising:
a mixture of polypropylene or polyethylene or both with the algae product; and
the bio-based plastic has a density equal to or less than 0.98 g/cm³; and
cells within the plastic.

15. The bio-based cellular plastic of claim 14, wherein the weight ratio range of the algae product to the polypropylene or polyethylene is 0.25 to 0.01.

16. The bio-based cellular plastic of claim 14, wherein the weight ratio range of the algae product to the polypropylene or polyethylene is 0.20 to 0.01.

17. The bio-based cellular plastic of claim 14, wherein the weight ratio range of the algae product to the polypropylene or polyethylene is 0.15 to 0.01.

18. The bio-based cellular plastic of claim 14, wherein the weight ratio range of the algae product to the polypropylene or polyethylene is 0.10 to 0.01.

19. The bio-based cellular plastic of claim 14, configured to be separated in floatation separation in fresh water.
